(19) United States
(12) Patent Application Publication
(10) Pub. No.: US 2006/0149428 A1
(43) Pub. Date: Jul. 6, 2006

(54) Emotion-based software robot for automobiles

(76) Inventors: Jong Hwan Kim, Daejeon (KR); Kang Hee Lee, Daejeon (KR); Jun Su Jang, Daejeon (KR); Yong Duk Kim, Daejeon (KR); Bum Joo Lee, Daejeon (KR); Yoon Ki Lee, Daejeon (KR); Mi Hoi Koo, Daejeon (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/305,693

(22) Filed: Dec. 15, 2005

(30) Foreign Application Priority Data
Jan. 5, 2005 (KR) 10-2005-0000670

(51) Int. Cl. G06F 17/00

(52) U.S. Cl. 701/1; 340/439

(57) ABSTRACT

An emotion-based software robot for automobiles, in which a driver's emotion and behavior caused by such emotion are anticipated when each input such as a driver's states, commands, and behaviors, automobile situations, automobile environmental situations, etc., is recognized based on results learned with respect to a change in emotion of each individual driver offline, as well as each piece of vehicle information, is assigned a priority, so that services provided by a telematics system, etc., can be selectively implemented to conform to a driver's mood.

### CROSS-REFERENCE TO RELATED APPLICATIONS

This application claims priority to and the benefit of Korean Patent Application No. 10-2005-0000670 filed in the Korean Intellectual Property Office on January 5, 2005, the entire contents of which are incorporated herein by reference.

### BACKGROUND OF THE INVENTION

1. Field of the Invention

The present invention relates to an emotion-based software robot for automobiles, and more particularly to a robot for automobiles in which each piece of vehicle information is assigned a priority by anticipating a driver's emotion and behaviors when input data such as driver's states, commands, and behaviors, automobile situations, automobile environmental situations, etc., are recognized based on learned information about each individual driver offline, so that services provided by a telematics system, etc., can conform to a driver's mood.

2. Background of the Related Art

In general, automobile systems are mainly associated with driver safety. Such systems are mainly hardware based, and may include sensors that sense risk of collision or grasp the state of a driver.

Further, conventional automobile systems provide a driver with a variety of feedback fanctions related to his or her own duties so as to improve driving performance.

Further, automobile telematics technologies manage various information ranging from automobile safety to entertainment. Services including such telematics technologies are based on a remote information system in which a server having digital information such as images, voices, videos and the like is connected to a wired/wireless network so as to provide a driver with driving information as well as various information necessary for life in real-time.

Such telematics services are classified into guidance of road and traffic information, safety and security, diagnosis of automobile states, provision of various information via the Internet, etc., for the purpose of their industrial application

There is a recent trend toward the transfer of much driving-related information to a driver for the purpose of securing his or her safety.

Conventional telematics technologies are focused on grasping the state of a driver based on a value preset at the time of manufacture of the automobile, and behave in response to stimuli. However, it is not easy to set any critical value for an individual driver within an actual driver group.

That is, the current state of the driver is checked to implement the driver behavior, but causes of the behavior are not sought. This problem arises from lack of system deviation according to each individual.

In connection with this, there have been many reports on the construction of telematics environment for conventional automobiles, which embraces a problem in that such construction lacks of standardability since it is based on the unilateral and subjective judgment of most people.

In addition, in the conventional prior art, there has been another problem in that a one-sided behavior implementation of a driver against changes in car driving environment while traveling drives him or her to distraction, thereby causing an accident.

There is therefore a growing need for the development of an automobile system that conforms to tastes and preferences of a driver.

### SUMMARY OF THE INVENTION

Accordingly, the present invention has been made in an effort to solve the above-mentioned problems occurring in the prior art, and it is an object of the present invention to provide an emotion-based software robot for automobiles, in which a driver's emotion and behavior are anticipated when input data such as a driver's states, commands and behaviors, automobile situations, automobile environmental situations, etc., are recognized based on results learned with respect to a change in emotion of each individual driver offline, as well as assigning each piece of vehicle information a priority, so that services provided by a telematics system, etc., can be implemented to conform to a driver's mood.

To accomplish the above object, according to embodiments of the present invention, there is provided an emotion-based software robot for automobiles, including:

a sensor system for receiving information data including a driver's current states, commands, and behaviors, automobile situations, and automobile environmental situations, and monitoring the received information, the sensor system including a state analyzer, a meaning analyzer, and a sensor extractor and encoder;

a presumption system for implementing data provided by a telematics system based on the information applied thereto from the sensor system, detecting the emotional state of the driver based on emotion data corresponding to an emotion value of the driver and analyzing the detected emotional state; and

a behavior selector and a motion system for accurately deriving the emotional state of the driver outputted from the presumption system and determining whether or not a service to be provided to the driver conforms to his or her mood so as to selectively implement the service.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a block diagram illustrating the inner construction of an emotion-based software robot for automobiles according to an embodiment of the present invention;

FIG. 2 is a diagrammatic view illustrating a service hierarchical structure depending on a priority controlled by an emotion-based software robot for automobiles according to the present invention;

FIG. 3 is a diagrammatical view illustrating driver emotion-presuming structure depending on input information applied to an emotion-based software robot for automobiles according to an embodiment of the present invention; and

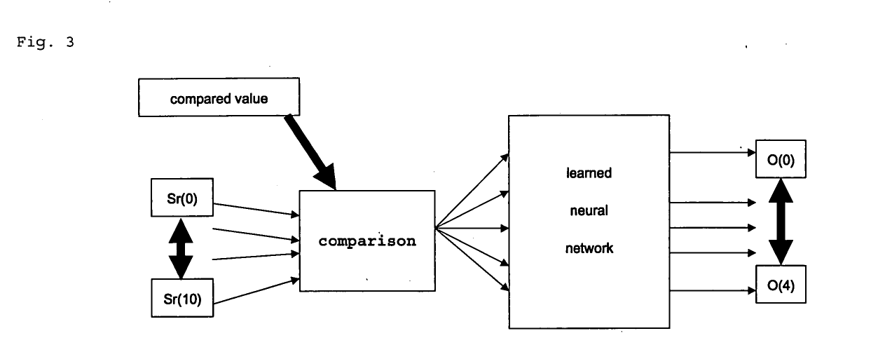

FIG. 4 is a schematic diagrammatic view illustrating the inter-relationship between emotions expressed by a driver and emotions expressed by a robot corresponding to the driver's emotions in an emotion-based software robot for automobiles according to an embodiment of the present invention.

### DETAILED DESCRIPTION OF THE PREFERRED EMBODIMENTS

Reference will now be made in detail to the preferred embodiment of the present invention with reference to the attached drawings.

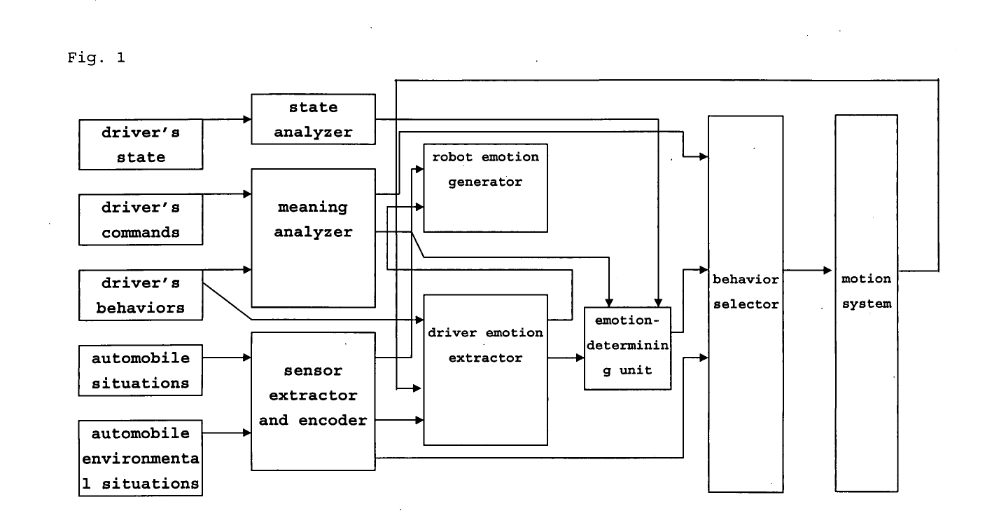

As shown in FIG. 1, the emotion-based software for automobiles according to the present invention is adapted to monitor various emotional data such as a driver's current states, commands and behaviors which are inputted independent of automobile situations, automobile environmental situations, etc., sense the monitored emotional data through a sensor system, compare the sensed emotional data with reference data preset in a presumption system, and accurately inquire about the driver's current mood again, if necessary, thereby comfortably and stably maintaining the optimal driving state of the driver.

A sensor system including a state analyzer, a meaning analyzer, and a sensor extractor and encoder serves to comprehensively receive several inputs obtained from the interior and the surroundings of an automobile, i.e., a driver's current states, command, and behaviors, automobile situations, and automobile environmental situations.

“The driver's states” refers to facial expressions, and “the state analyzer” refers to a section that recognizes such facial expressions.

“The driver's commands” refers to requests for various information and services about automobile situations and automobile environmental situations requested from the robot by the driver, and “the meaning analyzer” refers to a section that recognizes the driver's commands and then connecting the recognized commands with symbols stored in a database in terms of meanings.

“The driver's behaviors” refers to voice behaviors which reflect his or her mood and manipulation behaviors of an A/V system.

“The sensor extractor and encoder” refers to a section that recognizes various sensor values of an automobile and its environment, and then connects the recognized sensor values with predefined symbols so that the sensor values can be transformed into values readable by the robot.

The creation of robot's emotions is aimed at implicitly expressing the state of the automobile in robot's emotions based on input values of the automobile and environment sensor.

“A driver emotion extractor” refers to a section that presumes the driver's emotions based on a signal input to a neural network learned offline.

An emotion-determining unit serves to determine whether or not to recognize an emotion value based on a driver's facial expression and behavior at the moment when a driver's presumed emotion value is updated.

A behavior selector acts to implement telematics services of the robot in such a fashion as to check whether such implementation of services positively or negatively affect the driver based on anticipation of the driver's emotion to thereby determine whether to intercept a corresponding behavior or to encourage such corresponding behavior.

A motion system is a section that represents the behavior selected by the behavior selector in the form of voice, text and animation.

In this manner, the signal received and input by the sensor system is transferred to the presumption system having the emotion-determining unit built therein based on an emotion and sensibility engineering which measures a variation in a driver's emotions. The presumption system, which comprises a robot emotion generator, a driver emotion extractor, and an emotion-determining unit, receives the input signal from the sensor system and performs analysis of a driver's facial expressions, physiological signals like voice, etc.

That is, both general information data of automobiles and a driver's emotional state data are integrated depending on each weight value and are transformed into synthetic data to determine the driver's entire emotional state. At this time, in the case where the driver's emotional state needs to be changed, information for a corresponding emotional state is extracted adjusting from reference data preset based on the received information signal to generate an emotion-adjusting signal corresponding to the synthetic data for the driver's entire emotional state, and then is transferred to the behavior selector and the motion system.

In the meantime, the presumption system allows a processor associated with all the potential services which can be provided to a driver to be operated through the behavior selector and the motion system. The processor is designed to be represented in the behavioral implementation of the robot.

The presumption system is adapted to implement services provided by a telematics system. The presumption system also detects a driver's emotional state based on data applied thereto through the state analyzer, the meaning analyzer, and the sensor extractor and encoder and analyzes the driver's emotional state independently of such behavioral implementation to thereby determine whether or not a behavior to be expressed by the robot conforms to the driver's mood.

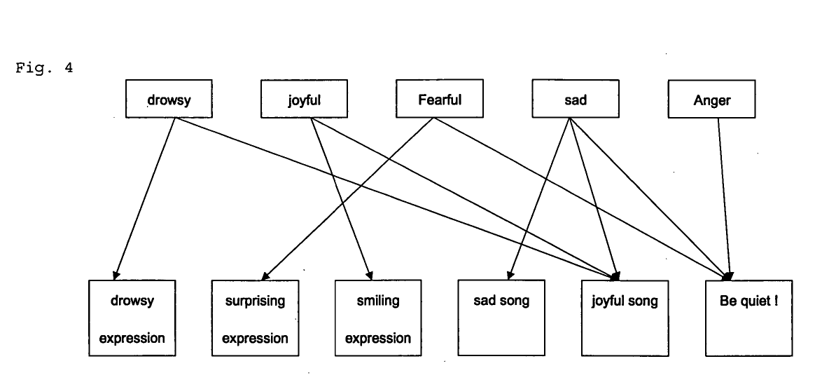

In this case, the robot's behavioral implementation is typically carried out through a display unit installed inside the automobile. In FIG. 4 is illustrated the inter-relationship between emotions expressed by a driver and emotions expressed by a robot correspondingly to the driver's emotions.

Further, each of various services extracted for respective data is assigned a priority. Among the various services, a service with a higher priority is implemented first.

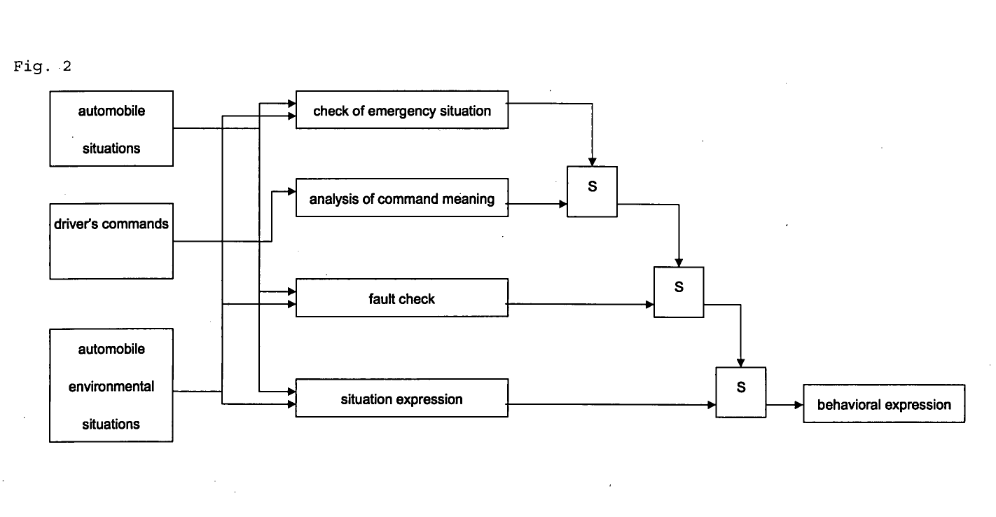

For instance, in shown in FIG. 2, when a driver's command is input to the robot, the robot first answers the command, unless it senses a risk factor connected directly with vehicle safety; then it issues only a warning for an emergency situation while ignoring the response to the driver's command.

In addition, the presumption system, to which inputs such as a driver's states, commands, and behaviors, automobile situations, automobile environmental situations, etc., are transferred, is configured in a learning structure in which a variety of emotional states is updated.

In other words, the emotion-determining unit included in the presumption system has a database for storing emotional evaluations for each individual driver. This database is preferably configured such that lots of variables are measured and classified for the purpose of evaluating a driver's emotion.

Particularly, the correlation between the variables increases exponentially in complexity as the number of variables increases. A personal characteristic is preferably applied for a more accurate evaluation of the driver's emotion.

For example, when the robot informs a driver that he or she has been caught in a traffic jam from a point 30 m ahead of the vehicle, the robot anticipates a change in his or her emotion while informing the driver, based on a learned result, how his or her emotion is changed in response to the robot's report.

Moreover, when a driver's emotion is expressed in one of the behaviors illustrated in FIG. 4, the robot judges that it knows his or her emotion with some certainty.

Accordingly, the emotion-based software robot for automobiles according to embodiments of the present invention as constructed above accurately detects a change in a driver's emotion and behaviorally copes with the emotional change appropriately, thereby improving comfort and stability during the driver's traveling.

As described above, according embodiments of an emotion-based software robot for automobiles, a driver's emotional state is evaluated objectively, and its evaluated result is synthesized so as to accurately measure and evaluate his or her emotion, thereby comfortably and stably maintaining an optimal driving state of the driver.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. An emotion-based software robot for automobiles, comprising:
a sensor system that receives information, the information comprising a driver's current states, commands, and behaviors, automobile situations, and automobile environmental situations, and monitors the information, the sensor system comprising a state analyzer, a meaning analyzer, and a sensor extractor and encoder;
a presumption system that implements data provided by a telematics system based on the information applied thereto from the sensor system, detects an emotional state of the driver based on emotion data that corresponds to an emotion information value of the driver, and analyzes the emotional state; and
a behavior selector and a motion system that detect the emotional state of the driver outputted from the presumption system, determine whether or not a service to be provided to the driver conforms to his or her mood, and selectively implements the service.
